(19) United States
(12) Patent Application Publication
(10) Pub. No.: US 2025/0352897 A1
(43) Pub. Date: Nov. 20, 2025

(54) INCREMENTAL APPLICATION SAVES FOR CONTENT STREAMING SYSTEMS

(71) Applicant: NVIDIA Corporation, Santa Clara, CA (US)

(72) Inventor: Michael Oxford, II, San Jose, CA (US)

(21) Appl. No.: 18/665,332

(22) Filed: May 15, 2024

(51) Int. Cl. A63F 13/493; G06F 9/455

(52) U.S. Cl. CPC A63F 13/493; G06F 9/45558; G06F 2009/45562

(57) ABSTRACT

In various examples, incremental application saves for content streaming systems is described herein. Systems and methods are disclosed that perform incremental saves during sessions associated with applications, such as a gaming application, and then use the incremental saves to retrieve most current states associated with the applications if one or more termination events occur. For instance, during a session of an application, data packages may be generated that represent changes to the application, such as changes to one or more files and/or one or more portions (e.g., a block(s)) of the file(s). As such, if a termination event occurs during the session, such as the session crashing, user data may be used to reload an initial state of the application at the beginning of the session while the data packages are then used to reload a most current state of the application before the termination event(s) occurred.

### BACKGROUND

Content streaming systems allow users to stream gaming applications to client devices during gaming sessions. For instance, at a start of a gaming session, a content streaming system may load an initial state associated with a gaming application, such as based on user data that is saved after a previous gaming session with the user. During the session, the content streaming system may then receive input data from a client device, update a state of the gaming application using the input data (e.g., move a character, change a level, etc.), and then send content data representing the updated state back to the client device for output by the client device. These processes may then continue to repeat until an end of the gaming session, where the content streaming application saves a new, current state associated with the gaming application. For instance, at the end of the gaming session, the content streaming system may update the user data to indicate any updates to the gaming application, such as by taking a snapshot of the entire disk that includes changes to files that occurred during the gaming session.

However, in some circumstances, one or more events may occur with the gaming session, such as the gaming session crashing, the gaming session freezing, the client device losing network connectivity with the content streaming system, and/or so forth which cause the gaming session to unexpectedly terminate. When such events occur, the user may thus lose all of the progress that the user made during the gaming session. For example, after loading the initial state of the gaming application, if the user proceeds through the gaming application for a given period of time, the content streaming system may lose data associated with the progress through the gaming application over the given period of time if the gaming session unexpectedly terminates. As such, and in these circumstances, the content streaming system may only be able to again provide the user with the initial state of the gaming application during a subsequent gaming session.

### SUMMARY

Embodiments of the present disclosure relate to incremental application saves for content streaming systems. Systems and methods are disclosed that perform incremental saves during sessions associated with applications, such as a gaming application, and then use the incremental saves to retrieve most current states associated with the applications if one or more termination events occur. For instance, such as at a start of a session, user data may be used to load an initial state associated with an application. Additionally, during the session, data packages may be generated that represent changes to the application, such as changes to one or more files and/or one or more portions (e.g., a block(s)) of the file(s). As such, if a termination event occurs during the session, such as the session crashing, the user data may be used to again reload the initial state of the application while the data packages are then used to reload a most current state of the application before the termination event(s) occurred. In some examples, once the session is complete, the systems and methods may then update the user data with data associated with the session (e.g., a snapshot of the disk) and/or cause the data packages to be deleted.

In contrast to conventional systems, such as those described above, the systems of the present disclosure generate and then save the data packages during the session, where the data packages include the data (e.g., the file(s), the portion(s) of the file(s), etc.) that was changed during the session. This way, and unlike the conventional systems, the current systems are still able to use the data packages to reload a current state of the application if an event occurs that causes the session to unexpectedly terminate. More specifically, and as described above, the conventional systems only save the updates to the application at the end of the session, such as by taking a snapshot of the entire disk. As such, if an event occurs during the session that causes the session to unexpectedly terminate, the conventional systems cannot reload the current state of the application before the termination event occurred since the conventional systems have yet to save data associated with changes that occurred during the session and up to when the termination event.

### BRIEF DESCRIPTION OF THE DRAWINGS

The present systems and methods for incremental application saves for content streaming systems are described in detail below with reference to the attached drawing figures, wherein:

FIG. 1A illustrates an example data flow diagram for a process of performing incremental saves associated with an application, in accordance with some embodiments of the present disclosure;

FIG. 1B illustrates an example of one or more application servers allocating resources to one or more client devices, in accordance with some embodiments of the present disclosure;

FIG. 2 illustrates an example of monitoring files in order to determine when file changes occur, in accordance with some embodiments of the present disclosure;

FIGS. 3A-3B illustrate examples of data packages that may be associated with incremental changes to an application, in accordance with some embodiments of the present disclosure;

FIGS. 4A-4B illustrate examples of updating data packages by removing duplicate data, in accordance with some embodiments of the present disclosure;

FIGS. 5A-5B illustrate examples of reloading a state associated with an application after an event occurs that unexpectedly terminates a session of the application, in accordance with some embodiments of the present disclosure;

FIG. 6 illustrates a flow diagram showing a method for storing incremental saves associated with an application, in accordance with some embodiments of the present disclosure;

FIG. 7 illustrates a flow diagram showing a method for updating incremental saves associated with an application, in accordance with some embodiments of the present disclosure;

FIG. 8 illustrates a flow diagram showing a method for generating a data package associated with an incremental save of an application, in accordance with some embodiments of the present disclosure;

FIG. 9 illustrates a flow diagram showing a method for restoring a state associated with an application using one or more incremental saves, in accordance with some embodiments of the present disclosure;

FIG. 10 is a block diagram of an example content streaming system suitable for use in implementing some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

Systems and methods are disclosed related to incremental application saves for content streaming systems. For instance, a system(s) may receive a request to start a session associated with an application, such as from a client device. As described herein, an application may include, but is not limited to, a gaming application (e.g., cloud gaming application), an interactive application, a multimedia application (e.g., a video streaming application, a music streaming application, a voice streaming application, a multimedia streaming application that includes both audio and video, etc.), a communications application (e.g., a video conferencing application, etc.), an educational application, a collaborative content creation application, or any other type of application. Based at least on receiving the request, the system(s) may then launch the session such that the application is in an initial state. In some examples, such as if a user is new to the application, the initial state may include a beginning of the application (e.g., a first level of a gaming application). In some examples, such as if the user has previously used the application, the initial state may include a previously saved state of the application from a previous session (e.g., a further level within the gaming application). In such examples, the system(s) may use user data associated with the user to determine the initial state, such as user data that includes data (e.g., a snapshot, an image, etc.) associated with the application after the previous session.

The system(s) may then allow the user to control the application, such as by playing a gaming application, during the session. For instance, during the session, the client device may generate input data representing one or more inputs received from the user via one or more input devices. The system(s) may then receive the input data from the user, use the input data to update a state of the application, and then send content data representing the current state of the application back to the client device. Using the content data, the client device may then provide the content to the user, such as by displaying one or more frames depicting the current state and/or outputting sound associated with the current state. For an example, if the application includes a gaming application where the user is controlling a character within a gaming environment, the system(s) may use the input data to update the location, action, the movement, and/or so forth of the character. The client device may then display one or more frames depicting the update(s) to the character. Additionally, this process may continue to repeat during the session such that the state of the application continues to update.

As described herein, the system(s) may be updating the state of the application by changing one or more files associated with the application. In some examples, a file change may include, but is not limited to, modifying a file (e.g., adding a block to the file, deleting a block from the file, updating a block within the file, etc.), adding a new file, deleting a current file, and/or performing any other type of update. As such, the system(s) may use one or more techniques to track the file changes that occur during the session associated with the application. For a first example, the system(s) may use a brute force technique where the system(s) scans an entire volume of the disk to check for changes to files and/or directories. For a second example, the system(s) may register a directory notification that indicates when files are changed. Still, for a third example, the system(s) may use a log (e.g., a journal) that is updated to indicate any changes to files and/or directories. While these are just a few example techniques of how the system(s) may track for file changes that occur with regard to the application, in other examples, the system(s) may use additional and/or alternative techniques.

The system(s) may also be configured to determine when the application is in a “quiet” state. As described herein, the normal activity level of the system(s) when providing the application may include a “baseline” state associated with the application while the quiet state may include a deviation (e.g., a significant deviation) from the baseline state. For instance, in some examples to detect a quiet state, and based at least on detecting a file change, the system(s) may start a timer. The system(s) may then use the timer to determine whether any other file changes occur during a threshold period of time. As described herein, the threshold period of time may include, but is not limited to, one millisecond, ten milliseconds, one second, five seconds, and/or any other period of time. In some examples, if the system(s) determines that another file change occurs during the threshold period of time, then the system(s) may restart the timer. However, in some examples, if the system(s) determines that another file change does not occur for a threshold period of time after a previous file change, then the system(s) may determine that the application is in a state, such as a quiet state (e.g., quiet-write state).

Additionally, or alternatively, in some examples, the system(s) may perform additional and/or alternative processes to determine when the application is in the quiet state. For instance, the system(s) may monitor the resource usage (e.g., hardware usage, processing usage, network bandwidth usage, etc.) and/or the processing activities (e.g., active processes and/or threads) and use this monitoring to determine when the application is in the quiet state. For a first example, the system(s) may determine that the application is in the quiet state based at least on the resource usage dropping, dropping by a threshold amount, and/or dropping below a threshold amount. For a second example, the system(s) may determine that the application is in the quiet state based at least on the processing activities dropping, dropping by a threshold amount, and/or dropping below a threshold amount.

In some examples, based at least on determining that the application is in the quiet state, the system(s) may generate a data package that includes data representing one or more files changes that occurred between when the initial file change was detected and the threshold period of time elapsed without any new file changes. As described herein, the data may represent a modified file, a new file, an indication of a deleted file, a new portion (e.g., block) within a file, a modified portion (e.g., block) of a file, an indication of a deleted portion (e.g., block) of a file, and/or any other changes to the file(s). In some examples, the system(s) may generate the data package to include additional data associated with the file change(s). For example, the additional data may include data representing a change log that indicates an identifier (e.g., a package number, etc.) associated with the data package, a timestamp associated with the data package (e.g., a time when the changes occurred, a time when the data package was generated, etc.), a list of the changes that occurred, and/or any other information, a sentinel-file that indicates that the data package is complete, a registry file that indicates the changes to be applied, and/or any other data. In some examples, the data package may then be encrypted to generate an encrypted data package. The system(s) may then store the data package in one or more memories, such as in association with the user data, the session, and/or the application. Additionally, the system(s) may then continue to perform these processes in order to generate and store one or more additional data packages that represent one or more additional file changes (e.g., one or more additional incremental updates) during the session associated with the application.

In some examples, the system(s) may perform one or more processes in order to reduce the amount of data that is stored with regard to the data package(s). For a first example, since the same file may be changed multiple times during the session, a first data package may include the file as changed at a first time and a second data package may include the file as changed at a second, later time. As such, in some examples, the system(s) may delete the file from the first data package since the second data package includes the most updated version of the file. For a second example, and again since the same file may be changed multiple times during the session, a first data package may include first data representing a first change to a portion of the file that occurred at a first time and a second data package may include second data representing a second change to the portion of the file at a second, later time. As such, in some examples, the system(s) may modify and/or delete the first data from the first data package since the second data from the second data package includes the most updated version of the portion of the file.

As described herein, by generating and storing the data package(s) during the session, if one or more events occur that cause the session to unexpectedly terminate, the system(s) is able to use the data package(s) to reload a current state associated with the application before the session terminated. As described herein, an event may include, but is not limited to, a crash (e.g., the system(s) crashing, the client device crashing, etc.), a freeze (e.g., the system(s) freezes, the client device freezes, the application freezing, etc.), a network connectivity problem, a timeout, and/or any other problem that may cause the session to suddenly terminate.

For instance, to reload the current state, the system(s) may launch a new session where the application is again in the initial state from the previous session. In some examples, the system(s) launches the new session by again using the user data. The system(s) may then use the data package(s) to change one or more files associated with the application such that the files of the application are similar to the files before the previous session terminated. For instance, the system(s) may use the data package(s) to add one or more files, delete one or more files, modify one or more files (e.g., modify one or more portions of one or more files), and/or perform any other type of change to one or more files. By changing the file(s) using the data package(s), the system(s) may put the application in a most current state before the previous session terminated such that the user does not lose any progress and/or losses only a minimal amount of progress made through the application during the previous session.

The system(s) may then continue to perform these processes during the new session, such as generating one or more new data packages representing changes that occur to one or more files during the new session. Additionally, if one or more events occur that cause the new session to also unexpectedly terminate, the system(s) may again use the data package(s) generated during the previous session as well as the data package(s) generated during the new session to again launch a session of the application at the most current state. In some examples, the system(s) may continue to perform these processes until a session associated with the application is complete (e.g., the user chooses to end the session). In some examples, once the session is complete, the system(s) may perform one or more operations.

For a first example, at the completion of the session, the system(s) may save the data package(s) associated with one or more (e.g., all) of the sessions in one or more memories, such as in association with the user profile, the application, and/or any other type of data. For a second example, at the completion of the session, the system(s) may save one or more (e.g., all) of the changes that occurred during one or more (e.g., all) of the sessions as part of a final save. For instance, the system(s) may take a snapshot of the disk, which represents at least the changes to the files associated with the application, and then save the snapshot in association with the user data. Additionally, in such an example, once the complete save occurs, the system(s) may delete one or more (e.g., all) of the data package(s) from the memory. In some examples, performing the final save may include one or more advantages over saving the data package(s), such as by reducing the amount of data that is stored and/or reducing the amount of time it may take to reload the current state of the application during a next session.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, a system for that provides one or more gaming applications, systems for performing simulation operations, systems for performing digital twin operations, systems implemented using an edge device, systems implementing large language models (LLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

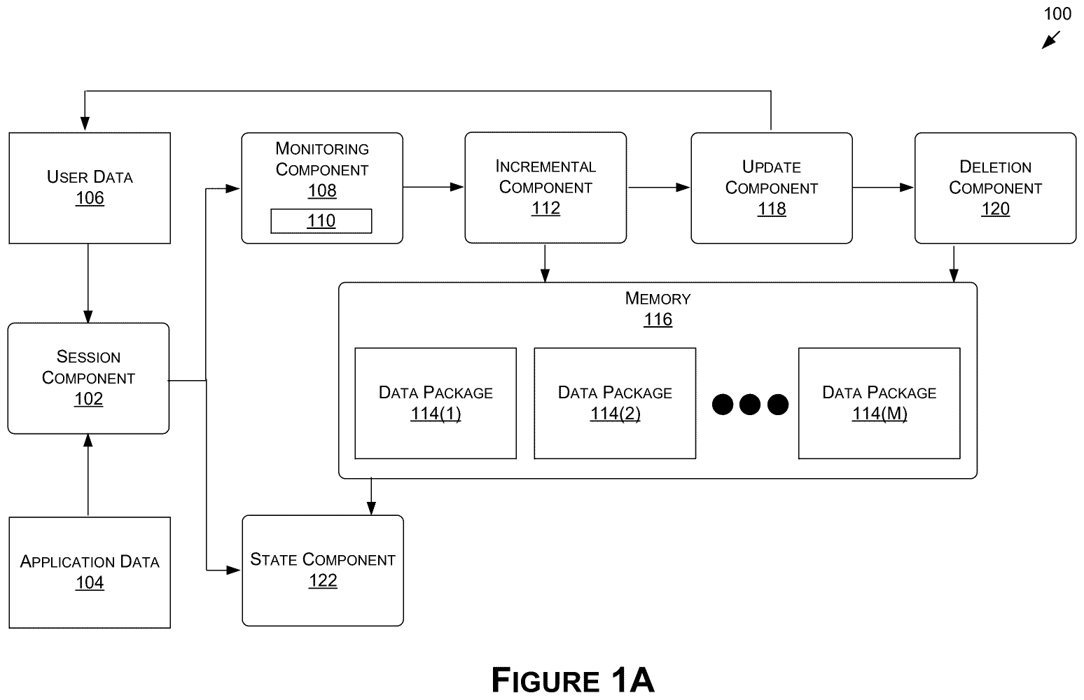

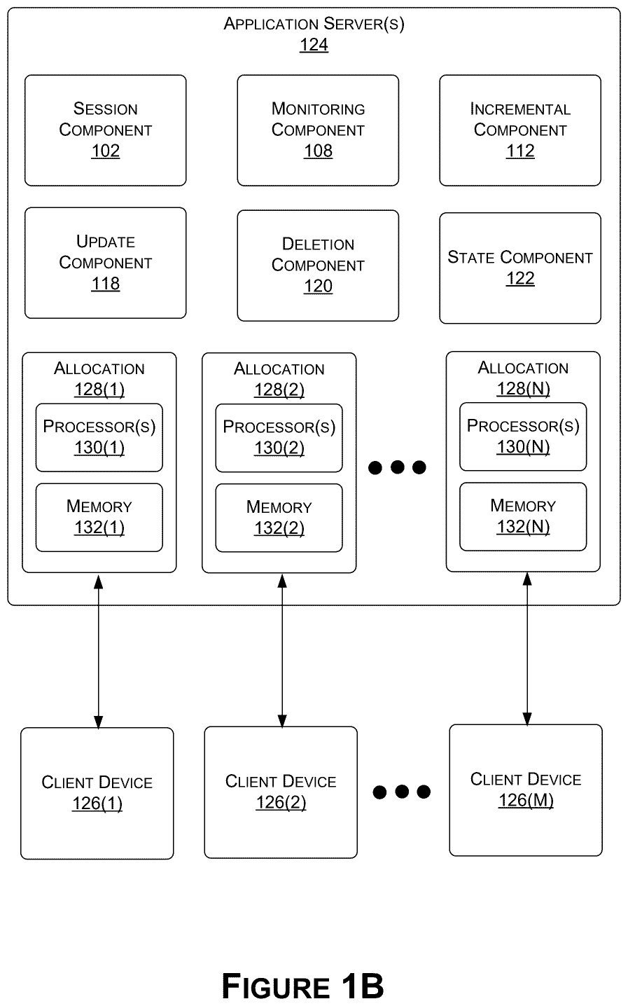

With reference to FIG. 1A, FIG. 1A illustrates an example data flow diagram for a process 100 of performing incremental saves associated with an application, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include a session component 102 receiving application data 104 representing an application that may be streamed to one or more client devices. As described herein, an application may include, but is not limited to, a gaming application (e.g., cloud gaming application), an interactive application, a multimedia application (e.g., a video streaming application, a music streaming application, a voice streaming application, a multimedia streaming application that includes both audio and video, etc.), a communications application (e.g., a video conferencing application, etc.), an educational application, a collaborative content creation application, or any other type of application. The process 100 may then include the session component 102 initiating a session associated with the application, such as by launching the application using one or more remote computing resources (e.g., one or more processors, one or more memories, one or more network interfaces, etc.). As described herein, when initially launching the application, the application may be associated with an initial state.

In some examples, such as if a user is new to the application and/or the user is just starting the application for a first time, then the initial state may include a beginning of the application. For example, if the application includes a gaming application, then the initial state may include a first level and/or beginning position within the gaming application. However, in some examples, such as if the user has accessed the application during a previous session, the process 100 may include the session component 102 receiving and then using user data 106 when launching the application. As described herein, the user data 106 may include at least data saved from a previous session, such as a snapshot and/or image of the application (e.g., a snapshot and/or image of the files associated with the application, a snapshot and/or image associated with a disk from the previous session, etc.). As such, the system(s) may use the user data 106 when launching the application such that initial state of the application includes a previous state of the application at the previous session. For example, and again if the application includes a gaming application, if the user ended the previous session at a fourth level, then the initial state of this application may include the user at the fourth level.

The process 100 may include using a monitoring component 108 to monitor for changes that occur to files associated with the application and during the session, where the changes may be caused by the session component 102 as the states of the application are updated. As described herein, in some examples, a file change may include, but is not limited to, modifying a file (e.g., adding data to the file, deleting data from the file, updating data within the file, etc.), adding a new file, deleting a current file, and/or performing any other type of change. As such, the monitoring component 108 may use one or more techniques to track the file changes that occur during the session associated with the application. For a first example, the monitoring component 108 may use a brute force technique where the monitoring component 108 scans an entire volume of the disk to check for changes to files and/or directories. For a second example, the monitoring component 108 may register a directory notification that indicates when files are changed.

Still, for a third example, the monitoring component 108 may use a log (e.g., a journal) 110 that is updated to indicate any changes to files and/or directories. For instance, whenever a change occurs with a file, the log 110 may be updated to indicate which file was changed, which portion of the file was changed, an offset within the file that is associated with the portion that was changed, a time of when the filed was changed, and/or any other information associated with the change to the file. While these are just a few example techniques of how the monitoring component 108 may track for file changes that occur with regard to the application, in other examples, the monitoring component 108 may use additional and/or alternative techniques to track the file changes.

In some examples, the monitoring component 108 may further monitor the application by determining, based at least on tracking the changes, one or more periods of time for which changes are not occurring, which may be referred to as a quiet state. For instance, based on detecting a file change at a first time, the monitoring component 108 may start a timer. The monitoring component 108 may then continue to track for file changes for a threshold period of time since starting the timer at the first time. If the monitoring component 108 determines that another file change has not occurred during the threshold period of time, then the monitoring component 108 may determine that a quiet state has occurred. However, if the monitoring component 108 determines that another file change occurs at a second time that is during the threshold period of time, then the monitoring component 108 may restart the timer at the second time and again for a threshold period of time. Additionally, the monitoring component 108 may continue to perform these processes until determining that a file change does not occur during a threshold period of time.

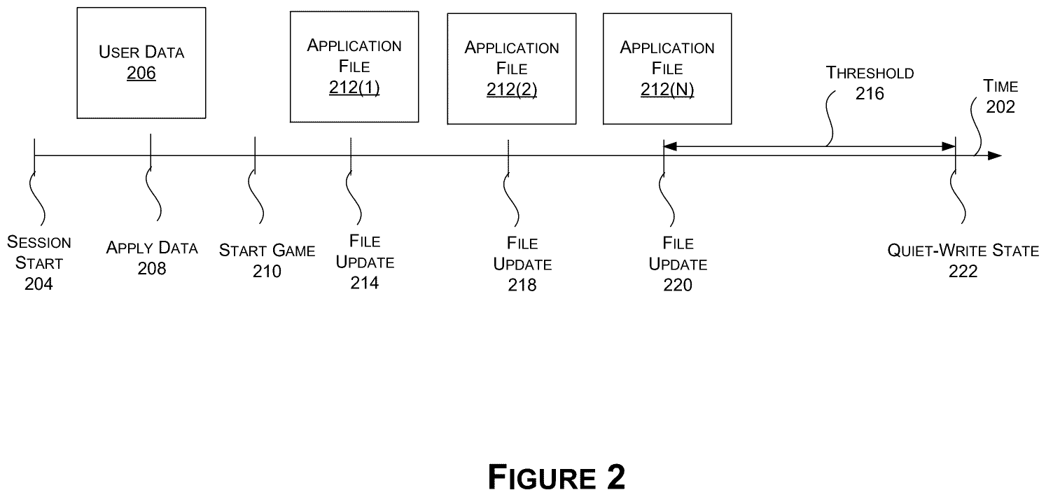

For instance, FIG. 2 illustrates an example of monitoring files in order to determine when file changes occur, in accordance with some embodiments of the present disclosure. As shown, over a period of time 202, the session component 102 may initially launch an application at a first time 204 and then apply user data 206 (which may be similar to, and/or represent, the user data 106) in order to load an initial state of the application at a second time 208. As described herein, by using the user data 206, the initial state may include a last state of the application during a previous session. The session component 102 may then cause the application to start at a third time 210 and, once the application is started, the monitoring component 108 may begin to monitor the files for changes.

For instance, the monitoring component 108 may determine that a file 212(1) is changed at a fourth time 214. As such, the monitoring component 108 may start a timer at the fourth time 214 and monitor for if another file change occurs during a threshold period of time 216. In the example of FIG. 2, the monitoring component 108 may determine that a file 212(2) is changed at a fifth time 218 which is within the threshold period of time from the fourth time 214. As such, the monitoring component 108 may restart the timer at the fifth time 218 and again monitor for if another file change occurs during the threshold period of time 216 after the fifth time 218. In the example of FIG. 2, the monitoring component 108 may determine that another file 212(N) is changed at a sixth time 220. As such, the monitoring component 108 may restart the timer at the sixth time 220 and again monitor for if another file change occurs during the threshold period of time 216 after the sixth time 220. As shown, the monitoring component 108 may then determine that the threshold period of time 216 elapses after the sixth time 220 using the timer. As such, the monitoring component 108 may determine that a quiet state occurs at a seventh time 222.

Referring back to the example of FIG. 1A, the monitoring component 108 may perform additional and/or alternative processes to determine when the application is in the quiet state. For instance, the monitoring component 108 may monitor the resource usage (e.g., hardware usage, processing usage, network bandwidth usage, etc.) and/or the processing activities (e.g., active processes and/or threads), where the amounts of usage may also be represented by 110, and use this monitoring to determine when the application is in the quiet state. For a first example, the monitoring component 108 may determine that the application is in the quiet state based at least on the resource usage dropping, dropping by a threshold amount, and/or dropping below a threshold amount. For a second example, the monitoring component 108 may determine that the application is in the quiet state based at least on the processing activities dropping, dropping by a threshold amount, and/or dropping below a threshold amount. As described herein, in some examples, the normal activity level of the system(s) when providing the application may include a “baseline” state associated with the application while the quiet state may include a deviation (e.g., a significant deviation) from the baseline state.

The process 100 may then include an incremental component 112 generating data packages 114(1)-(M) (also referred to singularly as “data package 114” or in plural as “data packages 114”), where the data packages 114 are then stored in memory 116. As described herein, the data packages 114 may represent changes (e.g., delta changes) to the application that occur during the session. Additionally, the incremental component 112 may generate a respective data package 114 at the occurrence of an event. As described herein, an event may include, but is not limited to, the monitoring component 108 determining that a quiet state occurs after a file change, a threshold period of time elapsing since last generating a data package 114, receiving an input (e.g., from a user) to generate a data package 114, and/or any other event.

For instance, and in the example of FIG. 1A, the monitoring component 108 may determine that one or more first file changes occurred during a first period of time that starts when an initial file change occurred and ends at a first quiet state. As such, the incremental component 112 may generate the first data package 114(1) that includes data associated with the first file change(s). Additionally, the monitoring component 108 may determine that one or more second file changes occurred during a second period of time that starts when an initial file change occurred and ends at a second quiet state. As such, the incremental component 112 may generate the second data package 114(2) that includes data associated with the second file change(s). Furthermore, this process may continue to repeat until the monitoring component 108 determines that one or more final file changes occurred during a final period of time that starts when an initial file change occurred and ends at a final quiet state. As such, the incremental component 112 may generate the final data package 114(M) that includes data associated with the final file change(s).

As described herein, in some examples, by using the timer to determine when there are quiet states before generating the data packages 114, the incremental component 112 may ensure that the files are no longer being updated and/or are no longer being updated for at least a period of time such that the data packages 114 capture at least a substantial amount (e.g., all) of the changes to the files. As such, in some examples, the monitoring component 108 may determine the threshold period of time in order to ensure that the changes to the files are complete for at least the period of time. This way, and as described in more detail herein, if the data packages 114 are later used to restore a most recent state associated with the application, the data packages 114 will represent at least a majority (e.g., all) of the changes to the files that occurred such that the most recent state associated with the application may be restored.

As described herein, the incremental component 112 may generate the data packages 114 to include various type of data. For example, a data package 114 may include, but is not limited to, one or more changed files, data representing one or more portions (e.g., one or more blocks) of the changed file(s), a change log that indicates an identifier (e.g., a package number) associated with the data package 114, a timestamp associated with the data package (e.g., a time when the changes occurred, a time when the data package was generated, etc.), a list of the changes that occurred, and/or any other information, a sentinel-file that indicates that the data package 114 is complete, a registry file that indicates one or more changes associated with the changed file(s) that is to be applied, and/or any other data. As described herein, a change may include, but is not limited to, to modify a file, to add a new file, to delete a current file, to modify a portion of a file, to add a portion of a file, to delete a portion of a file, and/or any other type of change that may occur to the files of the application.

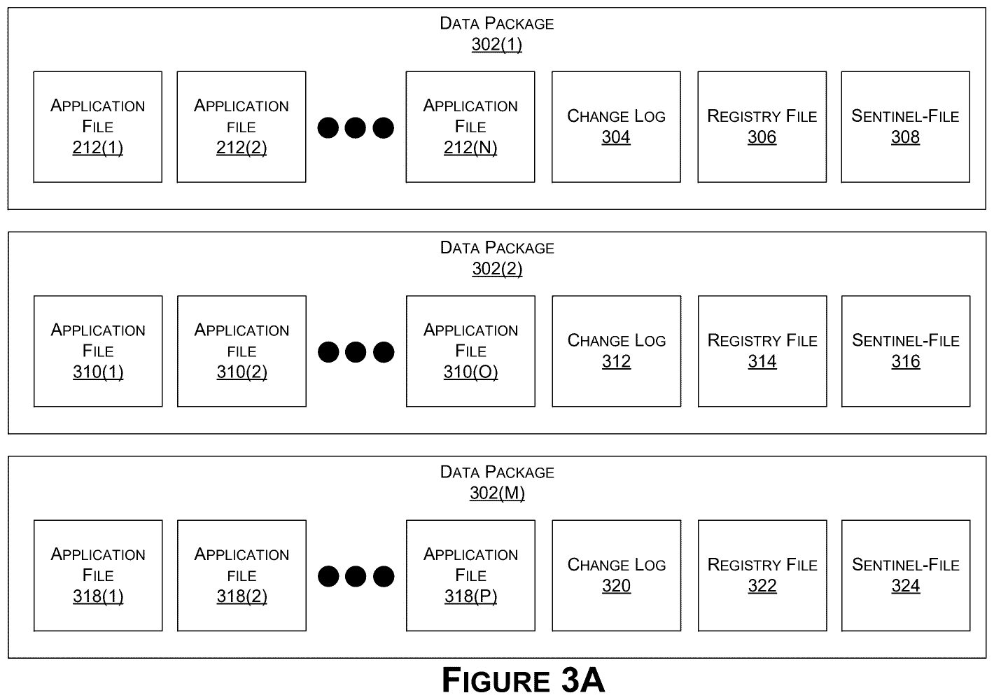

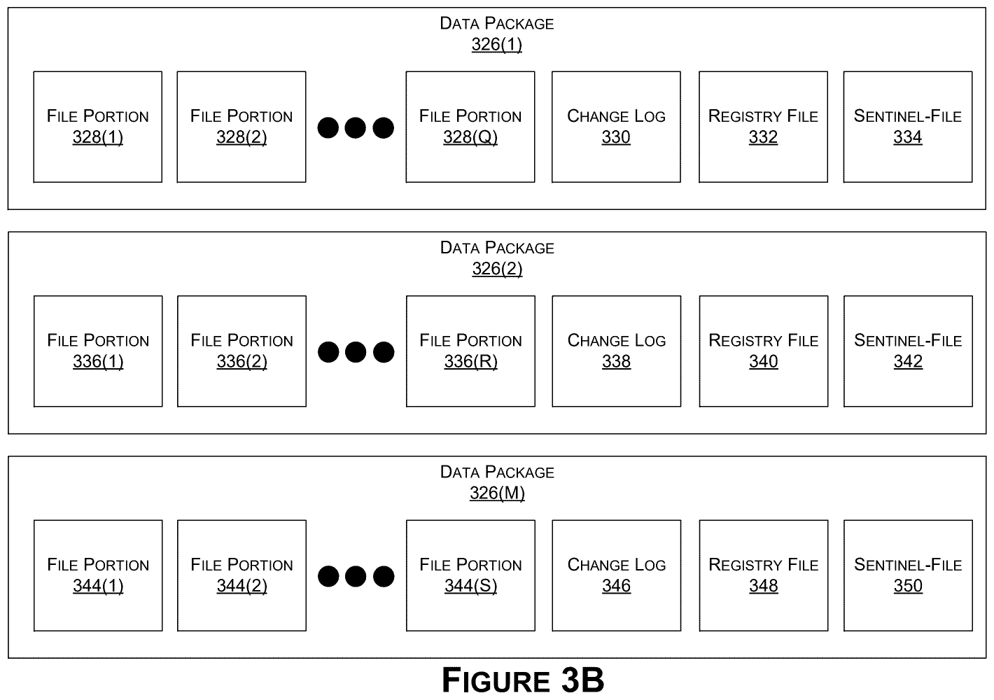

For instance, FIGS. 3A-3B illustrate examples of data packages that may be associated with incremental changes to an application, in accordance with some embodiments of the present disclosure. As shown by the example of FIG. 3A, the incremental component 112 may generate data packages 302(1)-(M) (also referred to singularly as “data package 302” or in plural as “data packages 302”), where the data packages 302 may represent and/or include the data packages 114 from the example of FIG. 1A. As further shown, the data package 302(1) may include at least the files 212 that were changed with regard to the example of FIG. 2, a change log file 304 that indicates at least an identifier associated with the data package 302(1), a registry file 306 that indicates the changes that occurred with regard to the files 212, and a sentinel-file 308 that indicates that the data package 302(1) is complete. Additionally, the data package 302(2) may include at least files 310(1)-(O) that were changed, a change log file 312 that indicates at least an identifier associated with the data package 302(2), a registry file 314 that indicates the changes that occurred with regard to the files 310(1)-(O), and a sentinel-file 316 that indicates that the data package 302(2) is complete. Finally, the data package 302(M) may include at least files 318(1)-(P) that were changed, a change log file 320 that indicates at least an identifier associated with the data package 302(M), a registry file 322 that indicates the changes that occurred with regard to the files 318(1)-(P), and a sentinel-file 324 that indicates that the data package 302(M) is complete.

As shown by the example of FIG. 3B, the incremental component 112 may generate data packages 326(1)-(M) (also referred to singularly as “data package 326” or in plural as “data packages 326”), where the data packages 326 may represent and/or include the data packages 114 from the example of FIG. 1A. As further shown, the data package 326(1) may include at least data representing portions 328(1)-(Q) of files that were changed, a change log file 330 that indicates at least an identifier associated with the data package 326(1), a registry file 332 that indicates the changes that occurred with regard to the portions 328(1)-(Q), and a sentinel-file 334 that indicates that the data package 326(1) is complete. Additionally, the data package 326(2) may include at least portions 336(1)-(R) of files that were changed, a change log file 338 that indicates at least an identifier associated with the data package 326(2), a registry file 340 that indicates the changes that occurred with regard to the portions 336(1)-(R), and a sentinel-file 342 that indicates that the data package 326(2) is complete. Finally, the data package 326(M) may include at least portions 344(1)-(S) of files that were changed, a change log file 346 that indicates at least an identifier associated with the data package 326(M), a registry file 348 that indicates the changes that occurred with regard to the portions 344(1)-(S), and a sentinel-file 350 that indicates that the data package 326(M) is complete.

While the examples of FIGS. 3A-3B illustrates the data packages 302 and 326 as including multiple files and/or multiple portions of files as being changed, in other examples, a data package may include any number of files and/or any number of portions of files that were changes. For a first example, a data package may include one changed file, five changed file, fifty changed files, and/or any other number of changed files. For a second example, a data package may include one changed portion, five changed portions, fifty changed portions, and/or any other number of changed portions. For a third example, a data package may include one changed filed (or any other number of changed files) and one changed portion (or any other number of changed portions).

Referring back to the example of FIG. 1A, in some examples, the incremental component 112 may perform one or more additional and/or alternative processes with respect to the data packages 114, such as to conserve resources (e.g., memory resources, processing resources, network resources, etc.). For a first example, since the same file may be changed multiple times during the session, a first data package 114 may include the file as changed at a first time instance and a second data package 114 may include the file as changed at a second, later time instance. As such, in some examples, the incremental component 112 may delete the file from the first data package 114 since the second data package 114 includes the most updated version of the file. For a second example, and again since the same file may be changed multiple times during the session, a first data package 114 may include first data representing a first change to a portion of the file that occurred at a first time and a second data package may include second data representing a second change to the portion of the file at a second, later time. As such, in some examples, the incremental component 112 may delete and/or modify the first data from the first data package 114 since the second data from the second data package 114 includes the most updated version of the portion of the file.

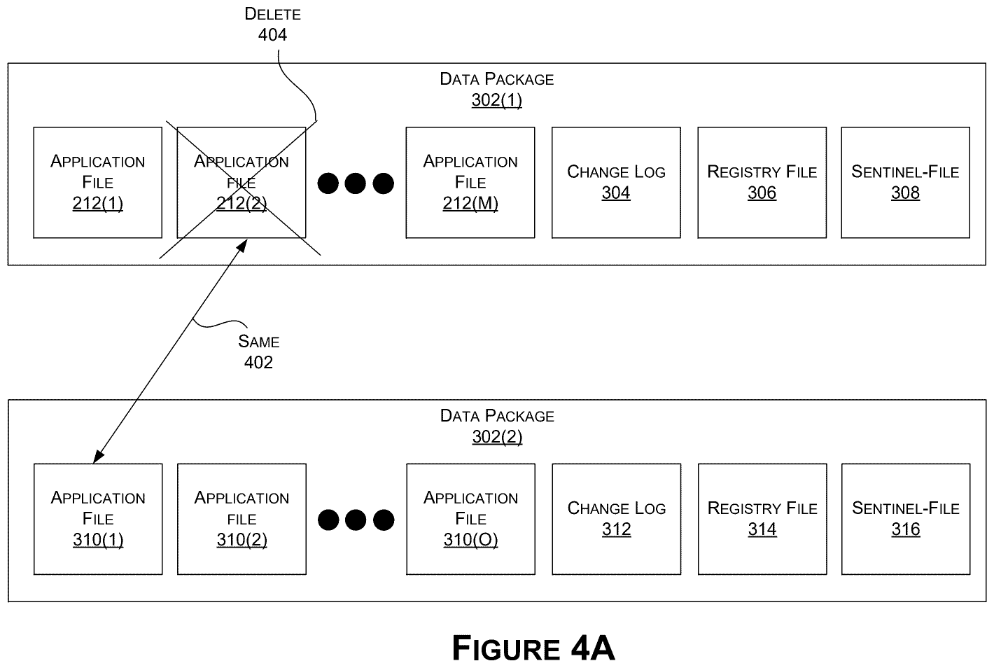

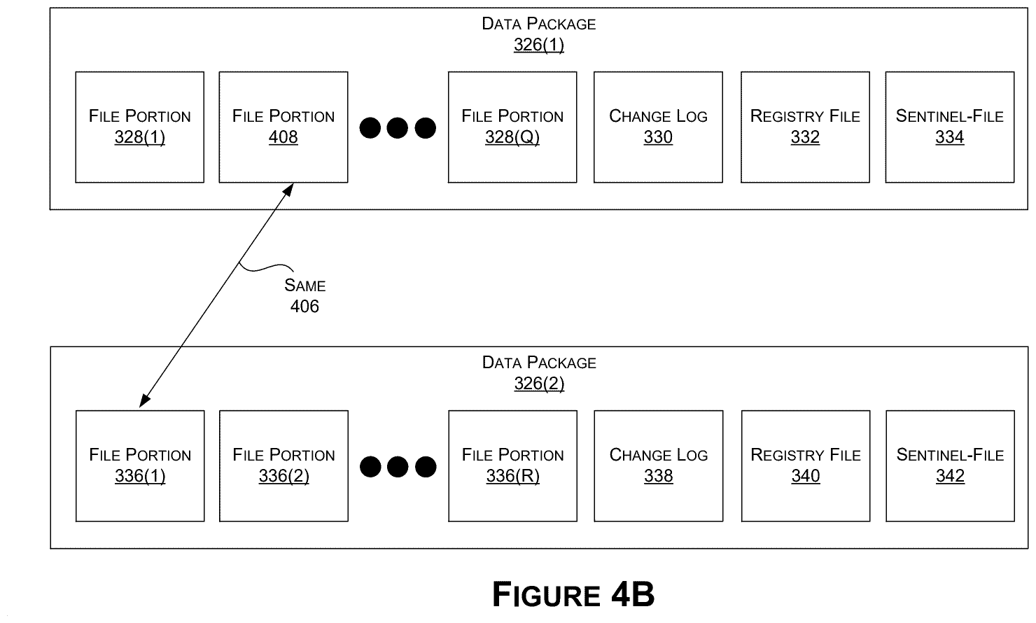

For instance, FIGS. 4A-4B illustrate examples of updating data packages by removing duplicate data, in accordance with some embodiments of the present disclosure. As shown by the example of FIG. 4A, the incremental component 112 may determine that the file 212(2) from the data package 302(1) corresponds to a same file as the file 310(1) from the data package 302(2), which is indicated by 402. In some examples, the incremental component 112 may perform one or more processes to make the determination, such as by determining that an identifier (e.g., a hash, etc.) associated with the file 212(2) matches an identifier (e.g., a hash, etc.) associated with the file 310(1). The incremental component 112 may then delete 404 the file 212(2) from the data package 302(1). In some examples, the incremental component 112 may delete the file 212(2) since the file 310(1) may include a more updated version as compared to the file 212(2). For instance, and based on the identifiers indicating that the data package 302(2) was generated after the data package 302(1), the file 212(2) may represent the file as changed at a first time while the file 310(1) represents additional changes that occurred to the file at a second, later time.

As shown by the example of FIG. 4B, the incremental component 112 may determine that the portion 328(2) of a file from the data package 326(1) corresponds to a same portion as the portion 336(1) of the file from the data package 326(2), which is indicated by 406. In some examples, the incremental component 112 may perform one or more processes to make the determination, such as by determining that an identifier (e.g., a hash, etc.) associated with the portion 328(2) matches an identifier (e.g., a hash, etc.) associated with the portion 336(1). The incremental component 112 may then modify the portion 328(2) from the data package 326(1), which is indicated by modified portion 408. In some examples, the incremental component 112 may modify the portion 328(2) since the portion 336(1) may include a more updated version as compared to the portion 328(2). For instance, and based on the identifiers indicating that the data package 326(2) was generated after the data package 326(1), the file portion 328(2) may represent the portion of the file as changed at a first time while the portion 336(1) represents additional changes that occurred to the portion of the file at a second, later time. In some examples, the incremental component 112 may further delete the file portion 336(1) after performing the modification to the file portion 408.

Referring back to the example of FIG. 1A, the process 100 may include an update component 118 determining when the session associated with the application is complete. In some examples, the update component 118 may determine that the session is complete based at least on the occurrence of one or more events. As described herein, an event may include, but is not limited to, the session component 102 ending the session based on user input, the session component 102 ending the session based on a period of time elapsing since a start of the session, and/or any other event. Based at least on determining that the session is complete, the process 100 may then include the update component 118 saving one or more (e.g., all) of the changes that occurred during the session. For example, the update component 118 may generate data (e.g., a snapshot, an image, etc.) representative of the disk, which represents at least the changes to the files associated with the application, and then save the data in association with the user data 106.

The process 100 may also include a deletion component 120 deleting one or more (e.g., all) of the data packages 114 from the memory 116. In some examples, the deletion component 120 may delete the data package(s) 114 based at least on the update component 118 saving the updates with respect to the user data 106 and/or the update component 118 verifying that the updates were saved correctly with regard to the user data 106. Additionally, or alternatively, in some examples, the deletion component 120 may delete the data package(s) 114 based at least on a new session associated with the application being initiated, where the new session was able to load in a correct state using the user data 106. While these are just a couple example events that may cause the deletion component 120 to delete the data package(s) 114 from the memory 116, in other examples, the deletion component 120 may delete the data package(s) 114 based at least on the occurrence of one or more additional and/or alternative events.

As described herein, in some examples, during the session associated with the application, rather than the session being complete, one or more events may occur with regard to the session that cause the session to unexpectedly terminate. As described herein, a termination event may include, but is not limited to, a crash (e.g., the system(s) crashing, the client device crashing, etc.), a freeze (e.g., the system(s) freezes, the client device freezes, the application freezing, etc.), a network connectivity problem, a timeout, and/or any other event that may cause the session to suddenly terminate. In some examples, when the session unexpectedly terminates, the process 100 may include starting a new session while also reloading the most current state associated with the application before the session terminated.

For instance, the process 100 may include the session component 102 initiating a new session associated with the application, such as by launching the application using one or more remote computing resources (e.g., one or more processors, one or more memories, one or more network components, etc.). Based at least on initiating the new session, the session component 102 receive and then use the user data 106 to reload an initial state of the application. Since the user data 106 may not have been updated since the launching of the previous session, by using the user data 106, the session component 102 may launch the new session such that the initial state includes the same initial state as the previous session (e.g., the progress from the previous session may initially be lost).

However, the process 100 may then include a state component 122 using one or more (e.g., all) of the data packages 114 to reload the most recent state of the application before the previous session was unexpectedly terminated. For instance, the state component 122 may apply changes represented the data from the data packages 114 to the files of the application. In some examples, the state component 122 may apply changes based on an order associated with the data packages 114. For a first example, such as if the data packages 114 store the changed files, the state component 122 may apply the first changed file(s) from the data package 302(1), followed by applying the second changed file(s) from the data package 302(2), and/or so forth until applying the last change file(s) form the data package 302(M). For a second example, such as if the data packages 114 store data representing portions of the changed files, the state component 122 may apply the first portion(s) of the first changed file(s) from the data package 326(1), followed by applying the second portion(s) of the second changed file(s) from the data package 326(2), and/or so forth until finally applying the last portion(s) of the last change file(s) form the data package 326(M).

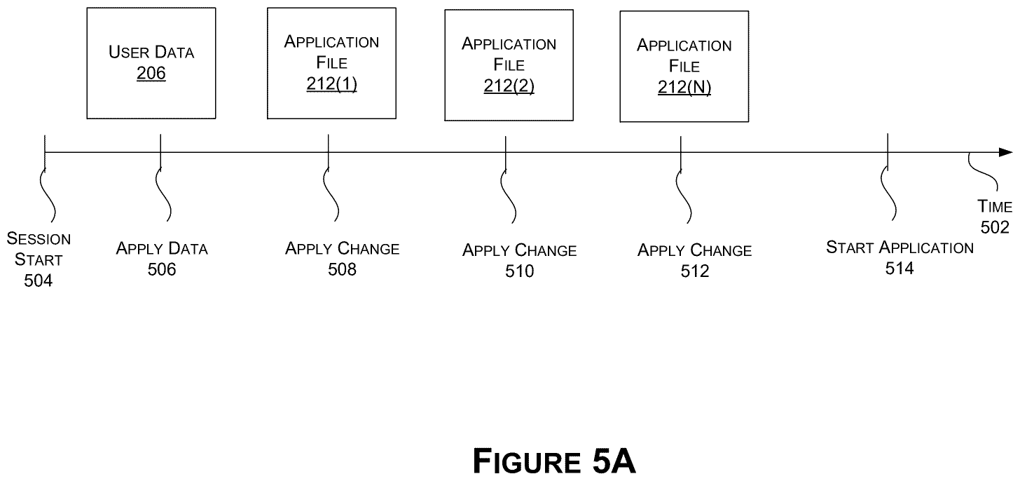

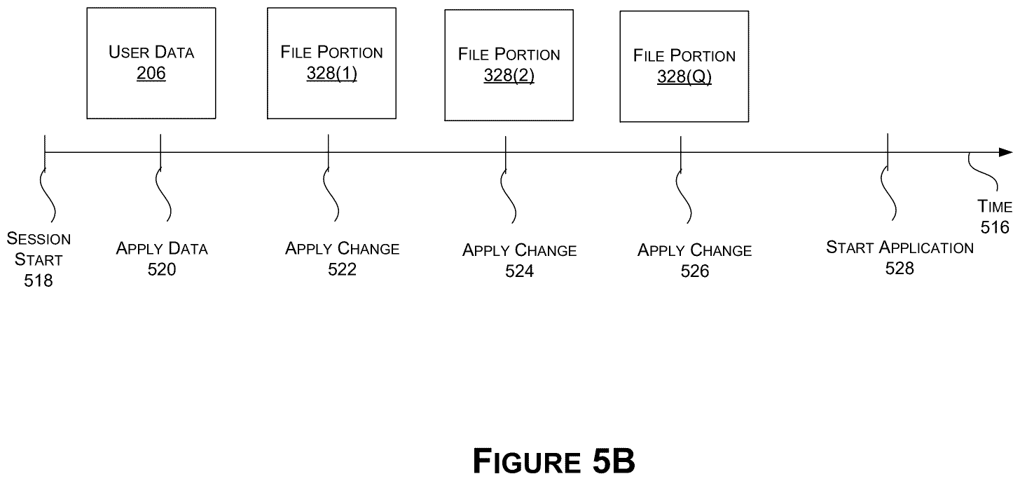

FIGS. 5A-5B illustrate examples of reloading a state associated with an application after an event occurs that unexpectedly terminates a session, in accordance with some embodiments of the present disclosure. As shown by the example of FIG. 5A, over a period of time 502, the session component 102 may initially launch an application at a first time 504 and then apply the user data 206 in order to load an initial state of the application at a second time 506, where the initial state may include the same initial state as described with respect to the example of FIG. 2 after applying the user data 206. The state component 122 may then apply the file 212(1) at a third time 508, apply the file 212(2) at a fourth time 510, and so forth until applying the file 212(N) at a fifth time 512. In some examples, applying a file 212 may include updating a corresponding file associated with the application with the changed file 212. The session component 102 may then start the application for the user at a sixth time 514. As such, by applying the files 212, the state of the application at the sixth time 514 may include a most current state of the application before the previous session unexpectedly terminated.

As shown by the example of FIG. 5B, over a period of time 516, the session component 102 may initially launch an application at a first time 518 and then apply the user data 206 in order to load an initial state of the application at a second time 520, where the initial state may include the same initial state as described with respect to the example of FIG. 2 after applying the user data 206. The state component 122 may then apply the portion 328(1) of the file at a third time 522, apply the portion 328(2) of the file at a fourth time 524, and so forth until applying the portion 328(Q) of the file at a fifth time 526. In some examples, applying a portion 328(1)-(Q) may include updating a corresponding portion of a file associated with the application with the changed portion 328(1)-(Q). The session component 102 may then start the application for the user at a sixth time 528. As such, by applying the portions 328(1)-(Q) of the files, the state of the application at the sixth time 528 may include a most current state of the application before the previous session unexpectedly terminated.

Referring back to the example of FIG. 1A, after the state component 122 reloads the most recent state associated with the application, then the process 100 may again include the monitoring component 108 monitoring changes that occur to files associated with the application and during the new session and/or detecting quiet states. Additionally, the incremental component 112 may generate and/or store one or more additional data packages 114 associated with the new session, where the additional data package(s) 114 may be stored in association with the data package(s) 114 from the previous session. This process 100 may then continue to repeat until the update component 118 performs one or more of the processes described herein to determine that a session associated with the application is complete. The update component 118 may then generate data (e.g., a snapshot, an image, etc.) representative of the application and/or the disk, which represents at least the changes to the files associated with the application during one or more (e.g., all) of the sessions, and then save the data in association with the user data 106. Additionally, the deletion component 120 may delete one or more (e.g., all) of the data packages 114 from one or more (e.g., all) of the sessions.

While these examples describe generating and/or saving one or more new data packages 114 during the new session along with the previously stored data package(s) 114 associated with the previous session, in other examples, other processes may be performed. For instance, after the state component 122 applies the changes at the start of the new session, the update component 118 may use the data package(s) 114 used to reload the most recent state to save one or more (e.g., all) of the changes that occurred during the previous session, similar to when the previous session was complete as described above. For example, the update component 118 may generate data (e.g., a snapshot, an image, etc.) representative of the disk, which represents at least the changes to the files associated with the application during the previous session, and then save the data in association with the user data 106. During the new session, the incremental component 112 may then generate and store one or more new data packages 114 associated with the new session.

In other words, the update component 118 may perform the processes described herein to save changes that occur at any point during a session and/or at any point between two sessions. Additionally, when the update component 118 performs these processes, the deletion component 120 may perform one or more of the processes described herein to delete the data package(s) 114 that may no longer be needed since the update component 118 performs the complete save.

In some examples, the components described herein may be executed using one or more computing devices. For a first example, the session component 102, the monitoring component 108, the incremental component 112, the update component 118, the deletion component 120, and/or the state component 122 may be executed using one or more application servers 1002 that are providing content to one or more client devices 1004. For a second example, the session component 102, the monitoring component 108, the incremental component 112, the update component 118, the deletion component 120, and/or the state component 122 may be separated between one or more application servers 1002 and one or more client devices 1004.

For instance, FIG. 1B illustrates an example of one or more application servers 124 allocating resources to one or more client devices 126(1)-(M) (also referred to singularly as “client device 126” or in plural as client devices 126″), in accordance with some embodiments of the present disclosure. As shown, the application server(s) 124 may allocate resources using one or more allocations 128(1)-(N) (also referred to singularly as “allocation 128” or in plural as “allocations 128”) for an application (e.g., cloud gaming application). Additionally, the resources associated with the allocations 128 may include at least processors 130(1)-(M) (also referred to as “processors 130”) and memory 132(1)-(M) (also referred to as “memory 132”). However, in other examples, additional and/or alternative resources may be provided by the allocations 128.

For instance, a virtual machine (VM) may spool on an application server 124 for a session associated with an application to begin. The application server 124 may provide the allocation 128(1) of resources, based on the application's needs, to the client device 126(1). The application may run entirely on the VM. The application server 124 may also perform at least a portion of the process 100 in order to generate incremental saves associated with the application. Additionally, during a session associated with an application, the application server 124 may provide the allocation 128(2) of resources to the client device 126(2). The application server 124 may also perform at least a portion of the process 100 in order to generate incremental saves associated with the application. Furthermore, during a session associated with an application, the application server 124 may provide the allocation 128(N) of resources to the client device 126(M). The application server 124 may also perform at least a portion of the process 100 in order to generate incremental saves associated with the application.

As described herein, in some examples, when a session associated with an application ends, such as the user causes the session to end (e.g., the user is finished playing the gaming application) and/or a termination event occurs that causes the session to unexpectedly end, a corresponding VM may power off, freeing up resources it was using. The application server 124 may no longer provide the allocation 128 of resources to the client device 126 and/or may provide the allocation 128 to a new client device 126. For instance, if the session associated with the client device 126(1) terminates based on one or more problems, the client device 126(1) may lose the allocation 128(1) of resources. Additionally, when the client device 126(1) attempts start a new session, then the client device 126(1) may receive a new allocation 128 of resources for the new session on the same application server or on a different application server. Because of this, if the application server(s) 124 does not generate the incremental saves, then the entire progress through the application and associated with the previous session may be lost. This is because the application server(s) 124 may only have the snapshot and/or image before the previous session began.

However, by performing the incremental saves described herein, the application server(s) 124 may be configured to reload a most current state associated with the application before the termination event occurred. For instance, if the client device 126(1) is allocated a new allocation 128 of resources for the new session, such as the allocation 128(2) of resources, the application server(s) 124 may still use the snapshot and/or image before the previous session, along with the incremental saves that occurred during the previous session and with regard to the allocation 128(1) of resources, to reload the most current state on the allocation 128(2) of resources for the user. In other words, even though the client device 126(1) is allocate different resources, such as different processors 130, memory 132, and/or any other resource, the application server(s) 124 is still able to reload the most recent state of the application for the user using the incremental saves.

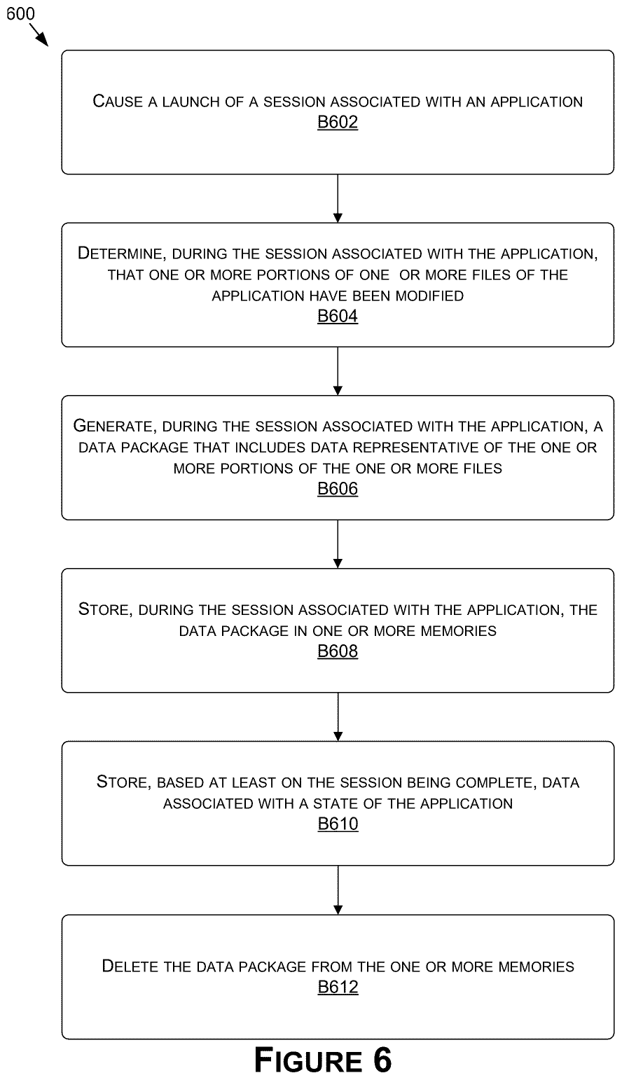

Now referring to FIGS. 6-9, each block of methods 600, 700, 800, and 900, described herein, comprises a computing process that may be performed using any combination of hardware, firmware, and/or software. For instance, various functions may be carried out by a processor executing instructions stored in memory. The methods 600, 700, 800, and 900 may also be embodied as computer-usable instructions stored on computer storage media. The methods 600, 700, 800, and 900 may be provided by a standalone application, a service or hosted service (standalone or in combination with another hosted service), or a plug-in to another product, to name a few. In addition, the methods 600, 700, 800, and 900 are described, by way of example, with respect to FIG. 1A. However, the methods 600, 700, 800, and 900 may additionally or alternatively be executed by any one system, or any combination of systems, including, but not limited to, those described herein.

FIG. 6 illustrates a flow diagram showing a method 600 for storing incremental saves associated with an application, in accordance with some embodiments of the present disclosure. The method 600, at block B602, may include causing a launch of a session associated with an application. For instance, the session component 102 may use the application data 104 to cause the launch of the session associated with the application, such as a gaming application. In some examples, the session component 102 may further use the user data 106 to load an initial state associated with the application, where the initial state includes a last state of a previous session associated with the application. For instance, the user data 106 may include at least data (e.g., a snapshot, an image, etc.) associated with the application at an end of the previous session, such as data representing the files of the application and/or a disk executing the application.

The method 600, at block B604, may include determining, during the session associated with the application, that one or more portions of one or more files of the application have been modified. For instance, the monitoring component 108 may use one or more of the techniques described herein to determine that the portion(s) of the file(s) has been modified. As described herein, the portion(s) of the file(s) may be modified based at least on a user progressing through the application such that the state of the application continues to update. For instance, and for a gaming application, the portion(s) of the file(s) may be modified as the user moves a character, switches to a new level, completes a task, identifies a new item, wins a game, and/or performs any other event associated with gaming applications. Additionally, in some examples, the monitoring component 108 may use one or more of the techniques described herein to determine that one or more quiet states occur between the portion(s) of the file(s) being modified.

The method 600, at block B606, may include generating, during the session associated with the application, a data package that includes data representative of the one or more portions of the one or more files. For instance, the incremental component 112 may generate the data package 114 that includes the data representing the portion(s) of the file(s). As described herein, in some examples, the data package 114 may include additional data, such as a change log that indicates an identifier (e.g., a package number) associated with the data package, a timestamp associated with the data package (e.g., a time when the changes occurred, a time when the data package was generated, etc.), a list of the changes that occurred, and/or any other information, a sentinel-file that indicates that the data package is complete, a registry file that indicates the changes to be applied, and/or any other data.

The method 600, at block B608, may include storing, during the session associated with the application, the data package in one or more memories. For instance, the incremental component 112 may store the data package 114 in the memory 116. In some examples, the incremental component 112 may initially encrypt the data package 114 and then store the encrypted data package 114 in the memory 116. Additionally, as described herein, the process 600 may then continue to repeat such that one or more additional data packages 114 associated with one or more additional changes to the application are stored in the memory 116 with the data package 114.

The method 600, at block B610, may include storing, based at least on the session being complete, data associated with a state of the application. For instance, the update component 118 may perform one or more of the processes described herein to determine that the session associated with the application is complete. Based at least on the session being complete, the update component 118 may then generate the data (e.g., a snapshot, an image, etc.) associated with the state of the application, such as data representing the disk and/or the change(s) to the file(s) that occurred during the session. The update component 118 may then store the data in association with the user data 106. This way, the most recent state of the application may be reloaded at a start of a new session.

The method 600, at block B612, may include deleting the data package from the one or more memories. For instance, the deletion component 120 may then delete the data package 114 from the memory. As described herein, in some examples, the deletion component 114 may delete the data package 114 based at least on the data being correctly stored by the update component 118.

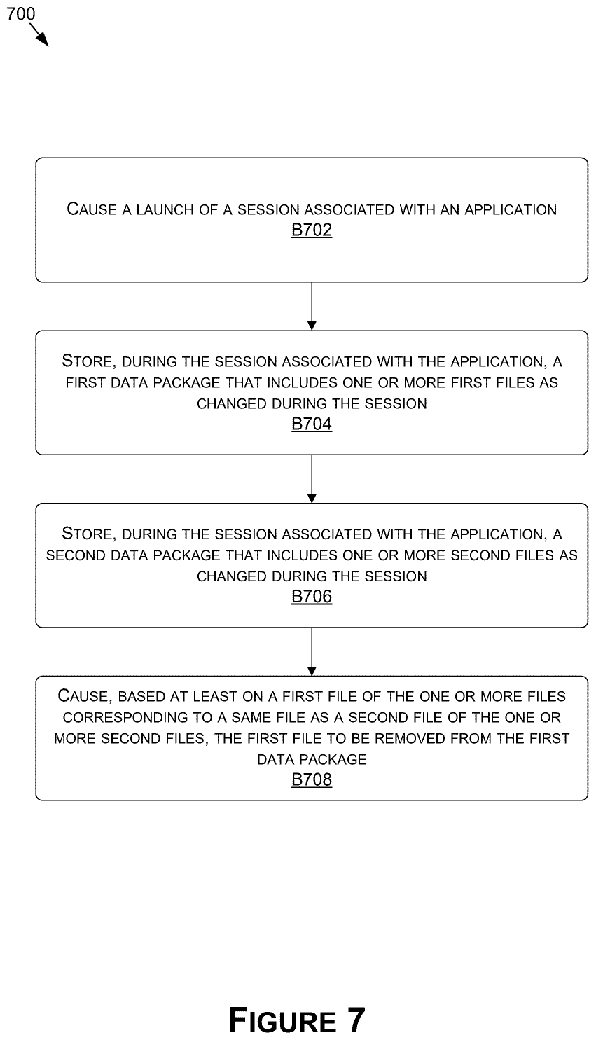

FIG. 7 illustrates a flow diagram showing a method 700 for updating incremental saves associated with an application, in accordance with some embodiments of the present disclosure. The method 700, at block B702, may include causing a launch of a session associated with an application. For instance, the session component 102 may use the application data 104 to cause the launch of the session associated with the application, such as a gaming application. In some examples, the session component 102 may further use the user data 106 to load an initial state associated with the application, where the initial state includes a last state of a previous session associated with the application. For instance, the user data 106 may include at least data (e.g., a snapshot, an image, etc.) associated with the application at an end of the previous session, such as data representing the files of the application and/or a disk executing the application.

The method 700, at block B704, may include storing, during the session associated with the application, a first data package that includes one or more first files as modified during the session. For instance, the incremental component 112 may generate the first data package 114 that includes the first file(s) as changed during the session. In some examples, and as described herein, the incremental component 112 may generate the first data package 114 based at least on the first file(s) being changed followed by a first quiet state occurring. However, in other examples, the incremental component 112 may generate the first data package 114 based on one or more additional and/or alternative events (e.g., monitoring resource usage and/or processing activity). In some examples, the first data package 114 may include data (e.g., a first snapshot, a first image, etc.) of the first file(s) that is generated during the first quiet state.

The method 700, at block B706, may include storing, during the session associated with the application, a second data package that includes one or more second files as changed during the session. For instance, the incremental component 112 may generate the second data package 114 that includes the second file(s) as modified during the session. In some examples, and as described herein, the incremental component 112 may generate the second data package 114 based at least on the second file(s) being changed followed by a second quiet-write state occurring. However, in other examples, the incremental component 112 may generate the second data package 114 based on one or more additional and/or alternative events (e.g., monitoring resource usage and/or processing activity). In some examples, the second data package 114 may include data (e.g., a second snapshot, a second image, etc.) of the second file(s) that is generated during the second quiet state.

The method 700, at block B708, may include removing, based at least on a first file from the one or more first files corresponding to a second file from the one or more second files, the first file to be removed from the first data package. For instance, the incremental component 112 may determine that the first file from the first file(s) corresponds to a same file of the application as the second file from the second file(s). For example, the first file may include the file of the application as changed at a first time and the second file may include the file of the application as changed at a second, later time. As such, based at least on the first file corresponding to the same file as the second file, the incremental component 112 may cause the first file to be removed from the first data package 114.

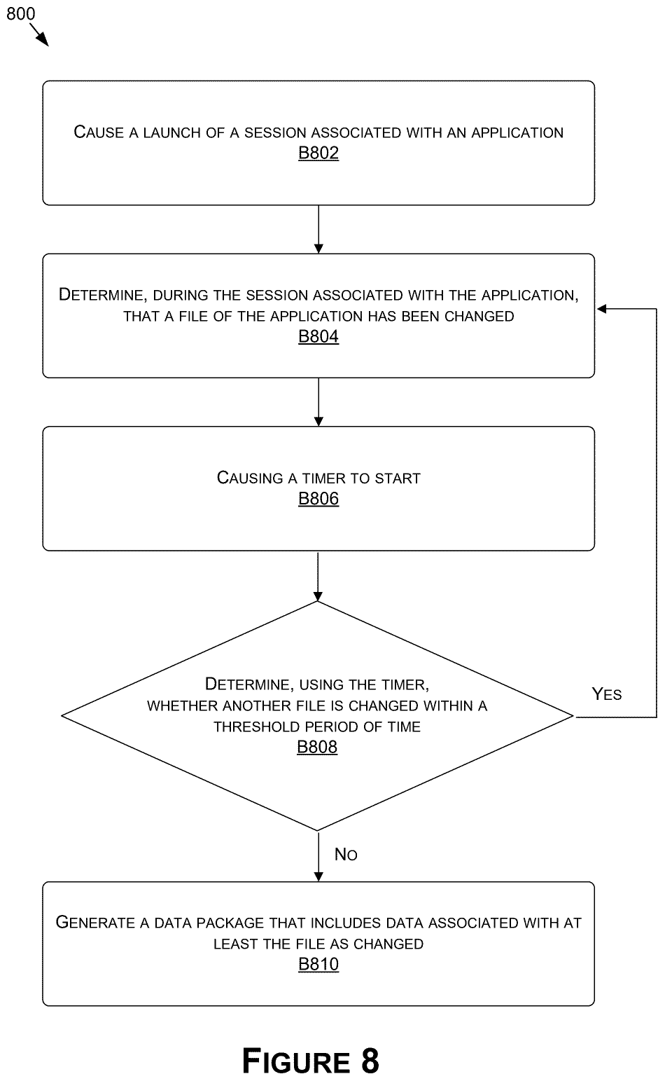

FIG. 8 illustrates a flow diagram showing a method 800 for generating a data package associated with an incremental save of an application, in accordance with some embodiments of the present disclosure. The method 800, at block B802, may include causing a launch of a session associated with an application. For instance, the session component 102 may use the application data 104 to cause the launch of the session associated with the application, such as a gaming application. In some examples, the session component 102 may further use the user data 106 to load an initial state associated with the application, where the initial state includes a last state of a previous session associated with the application. For instance, the user data 106 may include at least data (e.g., a snapshot, an image, etc.) associated with the application at an end of the previous session, such as data representing the files of the application and/or a disk executing the application.

The method 800, at block B804, may include determining, during the session associated with the application, that a file of the application has been changed and the method 800, at block B806, may include causing a timer to start. For instance, the monitoring component 108 may use one or more of the techniques described herein to determine that the file has been changed. As described herein, the file may be changed based at least on the file being modified, the file being added, the file being deleted, and/or based on any other type of change associated with the application. Based at least on the file being modified, the monitoring component 108 may then start the timer.

The method 800, at block B808, may include determining, using the timer, whether another file is changed during a threshold period of time. For instance, the monitoring component 108 may use the timer to determine whether the other file has been changed during the threshold period of time. As described herein, the monitoring component 108 may use one or more of the techniques described herein to determine whether the other file has been changed. If, at block B808, it is determined that the other file has been changed, then the process 800 may repeat starting back at B806. For instance, if the monitoring component 108 determines that the other file has been changed, then the monitoring component 108 may restart the timer. The monitoring component 108 may then again determine whether another file is changed for the threshold period of time using the restarted timer.

However, if, at block B808, it is determined that the other file has not been changed, then the method 800, at block B810, may include generating a data package that includes data associated with at least the file as changed. For instance, based at least on the other file not being modified during the threshold period of time, the incremental component 112 may generate the data package 114 that includes the data associated with at least the file. For a first example, the data may include the file and/or one or more additional files also modified. For a second example, the data may represent a portion of the file as changed and/or one or more additional portions of one or more additional files as changed. In some examples, the process 600 may then repeat starting back at block B804.

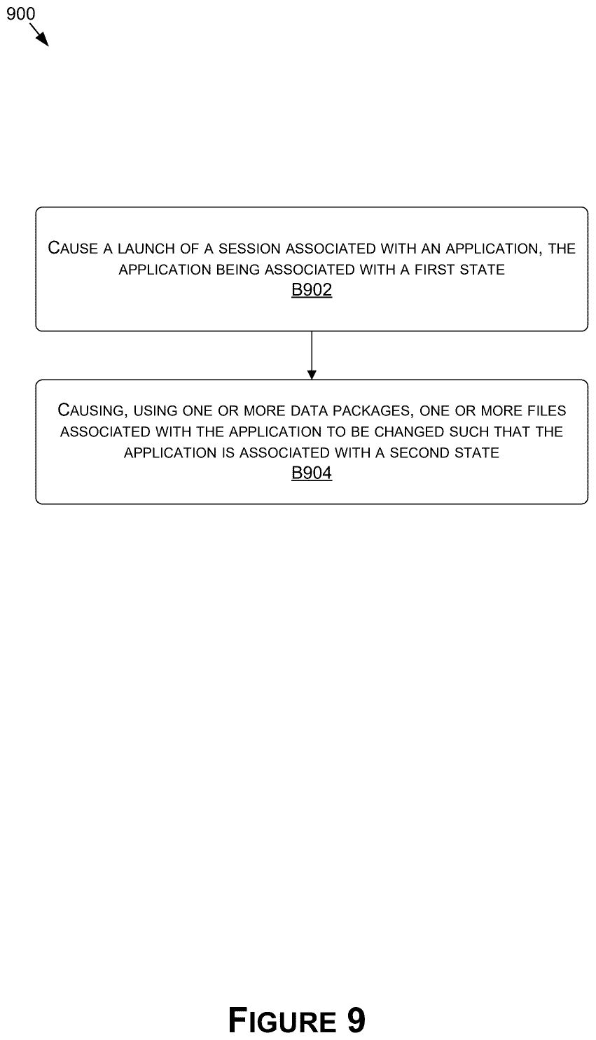

FIG. 9 illustrates a flow diagram showing a method 900 for restoring a state associated with an application using one or more incremental saves, in accordance with some embodiments of the present disclosure. The method 900, at block B902, may include causing a launch of a session associated with an application, the application being associated with a first state. For instance, the session component 102 may use the application data 104 to cause the launch of the session associated with the application, such as a gaming application. In some examples, the session component 102 may further use the user data 106 to load the first state associated with the application, where the first state includes a last state of a previous session associated with the application. For instance, the user data 106 may include at least data (e.g., a snapshot, an image, etc.) associated with the application at an end of the previous session, such as data representing the files of the application and/or a disk executing the application.

The method 900, at block B904, may include causing, using one or more data packages, one or more files associated with the application to be changed such that the application is associated with a second state. For instance, the state component 122 may use the data package(s) 114 to restore the last state of the application, where the last state may include the second state. As described herein, the state component 122 may restore the second state by applying changes to one or more files of the application based at least on the data included in the data package(s) 114.

### Example Content Streaming System

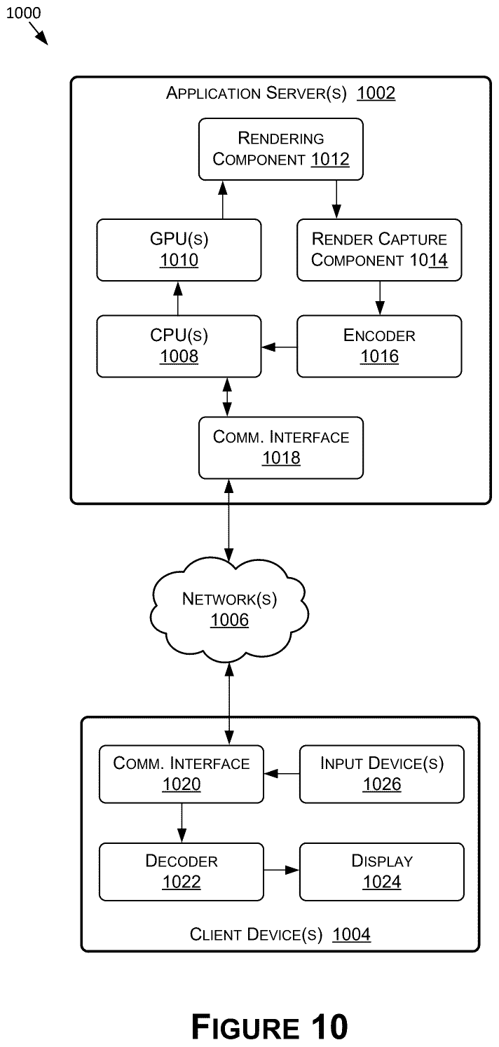

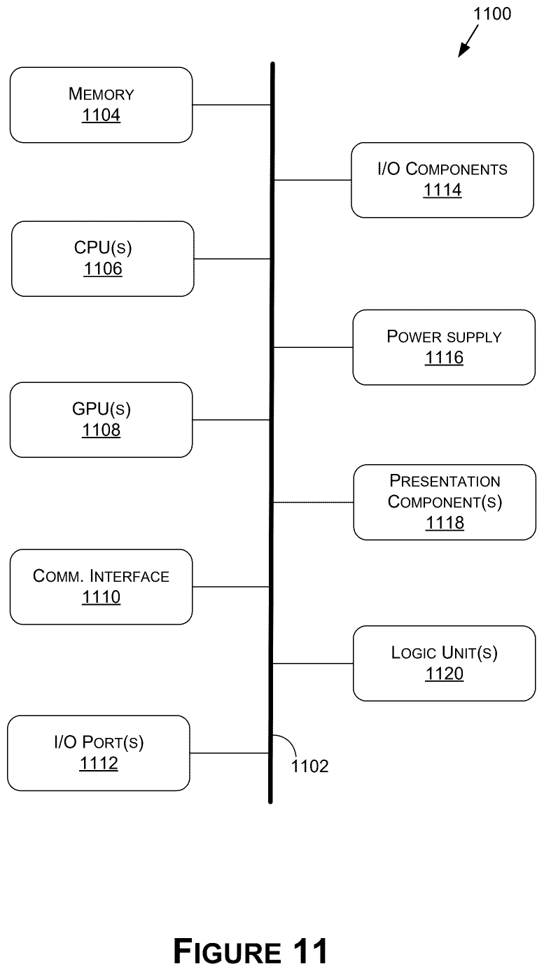

Now referring to FIG. 10, FIG. 10 is an example system diagram for a content streaming system 1000, in accordance with some embodiments of the present disclosure. FIG. 10 includes application server(s) 1002 (which may include similar components, features, and/or functionality to the example computing device 1100 of FIG. 11), client device(s) 1004 (which may include similar components, features, and/or functionality to the example computing device 1100 of FIG. 11), and network(s) 1006 (which may be similar to the network(s) described herein). In some embodiments of the present disclosure, the system 1000 may be implemented. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 1000, for an application session, the client device(s) 1004 may only receive input data in response to inputs to the input device(s), transmit the input data to the application server(s) 1002, receive encoded display data from the application server(s) 1002, and display the display data on the display 1024. As such, the more computationally intense computing and processing is offloaded to the application server(s) 1002 (e.g., rendering—in particular ray or path tracing—for graphical output of the application session is executed by the GPU(s) of the game server(s) 1002). In other words, the application session is streamed to the client device(s) 1004 from the application server(s) 1002, thereby reducing the requirements of the client device(s) 1004 for graphics processing and rendering.

For example, with respect to an instantiation of an application session, a client device 1004 may be displaying a frame of the application session on the display 1024 based on receiving the display data from the application server(s) 1002. The client device 1004 may receive an input to one of the input device(s) and generate input data in response. The client device 1004 may transmit the input data to the application server(s) 1002 via the communication interface 1020 and over the network(s) 1006 (e.g., the Internet), and the application server(s) 1002 may receive the input data via the communication interface 1018. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 1012 may render the application session (e.g., representative of the result of the input data) and the render capture component 1014 may capture the rendering of the application session as display data (e.g., as image data capturing the rendered frame of the application session). The rendering of the application session may include ray or path-traced lighting and/or shadow effects, computed using one or more parallel processing units-such as GPUs, which may further employ the use of one or more dedicated hardware accelerators or processing cores to perform ray or path-tracing techniques—of the application server(s) 1002. In some embodiments, one or more virtual machines (VMs)—e.g., including one or more virtual components, such as vGPUs, vCPUs, etc.—may be used by the application server(s) 1002 to support the application sessions. The encoder 1016 may then encode the display data to generate encoded display data and the encoded display data may be transmitted to the client device 1004 over the network(s) 1006 via the communication interface 1018. The client device 1004 may receive the encoded display data via the communication interface 1020 and the decoder 1022 may decode the encoded display data to generate the display data. The client device 1004 may then display the display data via the display 1024.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

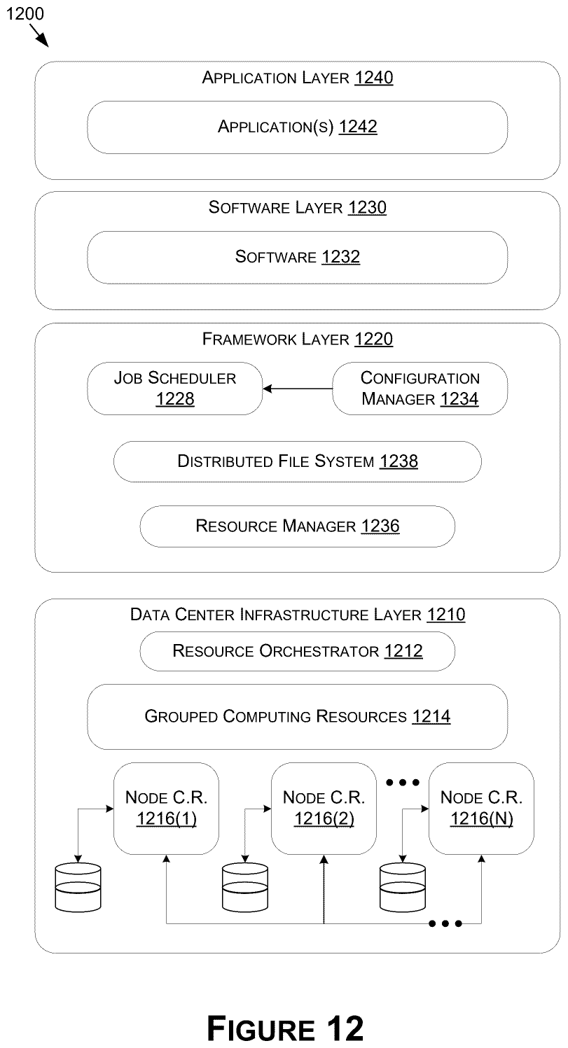

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161 (N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1228, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1228 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1228. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: causing a launch of a session associated with a gaming application; determining, during the session associated with the gaming application, that one or more portions of one or more files of the gaming application have been changed; generating, during the session associated with the gaming application, a data package that includes data representative of the one or more portions of the one or more files; and storing, during the session associated with the gaming application, the data package in one or more memories.

B: The method of paragraph A, further comprising: determining one or more types of changes that occurred to the one or more portions of the one or more files, the one or more types of changes including at least one of a deletion, an addition, or a modification; and generating the data package to further include second data representative of one or more types of changes.

C: The method of either paragraph A or paragraph B, further comprising: determining one or more offsets within the one or more files that are associated with the one or more portions of the one or more files; and generating the data package to further include second data representative of one or more offsets.

D: The method of any one of paragraphs A-C, further comprising: determining that one or more second files associated with the gaming application have not been changed during a threshold period of time since the determining that the one or more portions of the one or more files were changed, wherein the generating the data package is based at least on the determining that the one or more second files have not been changed during the threshold period of time.

E: The method of any one of paragraphs A-D, further comprising: after the storing the data package, determining, during the session of the gaming application, that one or more second portions of one or more second files of the gaming application have been changed; generating a second data package that includes second data representative of the one or more second portions of the one or more second files; and storing the second data package in the one or more memories and in association with the data package.

F: The method of paragraph E, further comprising: associating a first indicator with the data package; and associating a second indicator with the second data package, the second indicator indicating that a loading of the second data package occurs after a loading of the data package.

G: The method of any one of paragraphs A-F, further comprising: determining that an event has occurred that caused the session associated with the gaming application to terminate; based at least on the event occurring, causing a second launch of a second session associated with the gaming application; and applying, using the data from the data package, one or more changes to the one or more portions of the one or more files.

H: The method of paragraph G, further comprising: determining, during the second session associated with the gaming application, that one or more second portions of one or more second files of the gaming application have been changed; generating a second data package that includes second data representative of the one or more second portions of the one or more second files; and storing the second data package in the one or more memories and in association with the data package.

I: The method of any one of paragraphs A-H, further comprising: based at least on the session associated with the gaming application being complete, storing second data representative of a state associated with the gaming application at a time the gaming application is complete; and causing a deletion of the data package from the one or more memories.

J: The method of any one of paragraphs A-I, wherein the determining that the one or more portions of the one or more files has been changed is based at least on analyzing second data representative of a journal that indicates changes to files associated with the gaming application.

K: The method of any one of paragraphs A-J, further comprising: causing, for the session associated with the gaming application, a spool of a virtual machine (VM) and an allocation of at least one of one or more processing resources or one or more memory resources for the VM; based at least on the causing the launch of the session associated with the gaming application, updating, using the at least one of the one or more processing resources or the one or more memory resources, a state of the gaming application based at least on a portion of user data corresponding to a previous session associated with the gaming application, wherein the storing of the data package is in association with the user data.

L: A system comprising: one or more processors to: allocate, during a session associated with a gaming application, at least one of one or more processing resources or one or more memory resources to a client device; store, during the session associated with the gaming application, a first data package that includes one or more first files as changed during the session; store, during the session associated with the gaming application, a second data package that includes one or more second files as changed during the session; and cause, based at least on a first file of the one or more first files corresponding to a same file as a second file of the one or more second files, the first file to be removed from the first data package.

M: The system of paragraph L, wherein: the first data package further includes one or more first identifiers associated with the one or more first files; the second data package includes one or more second identifiers associated with the one or more second files; and the one or more processors are further to determine that the first file corresponds to the same file as the second file based at least on a first identifier of the one or more first identifiers being similar to a second identifier of the one or more second identifiers.

N: The system of either paragraph L or paragraph M, wherein the one or more processors are further to: associate a first indicator with the first data package; and associate a second indicator with the second data package, the second indicator indicating that a loading of the second data package occurs after a loading of the first data package, wherein the first file is removed from the first data package based at least on the first indicator and the second indicator.

O: The system of any one of paragraphs L-N, wherein the one or more processors are further to: determine, during the session associated with the gaming application, that the one or more first files have been changed; determine that a first threshold period of time has elapsed since the one or more first files were changed; generate, during the session associated with the gaming application and based at least on the first threshold period of time elapsing, the first data package to include the one or more first files; determine, during the session associated with the gaming application, that the one or more second files have been modified; determine that a second threshold period of time has elapsed since the one or more second files were changed; and generate, during the session associated with the gaming application and based at least on the second threshold period of time elapsing, the second data package to include the one or more second files.

P: The system of any one of paragraphs L-O, wherein the one or more processors are further to: determine, during the session associated with the gaming application, one or more first usage amounts associated with at least one of the one or more processing resources or the one or more memory resources; generate, during the session associated with the gaming application and based at least on the one or more first usage amounts, the first data package to include the one or more first files; determine, during the session associated with the gaming application, one or more second usage amounts associated with at least one of the one or more processing resources or the one or more memory resources; and generate, during the session associated with the gaming application and based at least on the one or more second usage amounts, the second data package to include the one or more second files.

Q: The system of any one of paragraphs L-P wherein the one or more processors are further to: determine that an event has occurred with that caused the session associated with the gaming application to terminate; based at least on the event occurring, allocate, during a second session associated with the gaming application, at least one of one or more second processing resources or one or more second memory resources to the client device; apply, using the first data package and using the at least one of the one or more second processing resources or the one or more second memory resources, one or more first changes to a first portion of files associated with the gaming application; and apply, using the second data package and using the at least one of the one or more second processing resources or the one or more second memory resources, one or more second changes to a second portion of the files associated with the gaming application.

R: The system of any one of paragraphs L-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: One or more processors comprising: processing circuitry to store one or more data packages during a session associated with a gaming application, the one or more data packages including data representing one or more portions of one or more files that were changed during the session associated with the gaming application.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
causing a launch of a session associated with a gaming application;
determining, during the session associated with the gaming application, that one or more portions of one or more files of the gaming application have been changed;
generating, during the session associated with the gaming application, a data package that includes data representative of the one or more portions of the one or more files; and
storing, during the session associated with the gaming application, the data package in one or more memories.

2. The method of claim 1, further comprising:
determining one or more types of changes that occurred to the one or more portions of the one or more files, the one or more types of changes including at least one of a deletion, an addition, or a modification; and
generating the data package to further include second data representative of one or more types of changes.

3. The method of claim 1, further comprising:
determining one or more offsets within the one or more files that are associated with the one or more portions of the one or more files; and
generating the data package to further include second data representative of one or more offsets.

4. The method of claim 1, further comprising:
determining that one or more second files associated with the gaming application have not been changed during a threshold period of time since the determining that the one or more portions of the one or more files were changed,
wherein the generating the data package is based at least on the determining that the one or more second files have not been changed during the threshold period of time.

5. The method of claim 1, further comprising:
after the storing the data package, determining, during the session of the gaming application, that one or more second portions of one or more second files of the gaming application have been changed;
generating a second data package that includes second data representative of the one or more second portions of the one or more second files; and
storing the second data package in the one or more memories and in association with the data package.

6. The method of claim 5, further comprising:
associating a first indicator with the data package; and
associating a second indicator with the second data package, the second indicator indicating that a loading of the second data package occurs after a loading of the data package.

7. The method of claim 1, further comprising:
determining that an event has occurred that caused the session associated with the gaming application to terminate;
based at least on the event occurring, causing a second launch of a second session associated with the gaming application; and
applying, using the data from the data package, one or more changes to the one or more portions of the one or more files.

8. The method of claim 7, further comprising:
determining, during the second session associated with the gaming application, that one or more second portions of one or more second files of the gaming application have been changed;
generating a second data package that includes second data representative of the one or more second portions of the one or more second files; and
storing the second data package in the one or more memories and in association with the data package.

9. The method of claim 1, further comprising:
based at least on the session associated with the gaming application being complete, storing second data representative of a state associated with the gaming application at a time the gaming application is complete; and
causing a deletion of the data package from the one or more memories.

10. The method of claim 1, wherein the determining that the one or more portions of the one or more files has been changed is based at least on analyzing second data representative of a journal that indicates changes to files associated with the gaming application.

11. The method of claim 1, further comprising:
causing, for the session associated with the gaming application, a spool of a virtual machine (VM) and an allocation of at least one of one or more processing resources or one or more memory resources for the VM;
based at least on the causing the launch of the session associated with the gaming application, updating, using the at least one of the one or more processing resources or the one or more memory resources, a state of the gaming application based at least on a portion of user data corresponding to a previous session associated with the gaming application,
wherein the storing of the data package is in association with the user data.

12. A system comprising:
one or more processors to:
allocate, during a session associated with a gaming application, at least one of one or more processing resources or one or more memory resources to a client device;
store, during the session associated with the gaming application, a first data package that includes one or more first files as changed during the session;
store, during the session associated with the gaming application, a second data package that includes one or more second files as changed during the session; and
cause, based at least on a first file of the one or more first files corresponding to a same file as a second file of the one or more second files, the first file to be removed from the first data package.

13. The system of claim 12, wherein:
the first data package further includes one or more first identifiers associated with the one or more first files;
the second data package includes one or more second identifiers associated with the one or more second files; and
the one or more processors are further to determine that the first file corresponds to the same file as the second file based at least on a first identifier of the one or more first identifiers being similar to a second identifier of the one or more second identifiers.

14. The system of claim 12, wherein the one or more processors are further to:
associate a first indicator with the first data package; and
associate a second indicator with the second data package, the second indicator indicating that a loading of the second data package occurs after a loading of the first data package,
wherein the first file is removed from the first data package based at least on the first indicator and the second indicator.

15. The system of claim 12, wherein the one or more processors are further to:
determine, during the session associated with the gaming application, that the one or more first files have been changed;
determine that a first threshold period of time has elapsed since the one or more first files were changed;
generate, during the session associated with the gaming application and based at least on the first threshold period of time elapsing, the first data package to include the one or more first files;
determine, during the session associated with the gaming application, that the one or more second files have been modified;
determine that a second threshold period of time has elapsed since the one or more second files were changed; and
generate, during the session associated with the gaming application and based at least on the second threshold period of time elapsing, the second data package to include the one or more second files.

16. The system of claim 12, wherein the one or more processors are further to:
determine, during the session associated with the gaming application, one or more first usage amounts associated with at least one of the one or more processing resources or the one or more memory resources;
generate, during the session associated with the gaming application and based at least on the one or more first usage amounts, the first data package to include the one or more first files;
determine, during the session associated with the gaming application, one or more second usage amounts associated with at least one of the one or more processing resources or the one or more memory resources; and
generate, during the session associated with the gaming application and based at least on the one or more second usage amounts, the second data package to include the one or more second files.

17. The system of claim 12, wherein the one or more processors are further to:
determine that an event has occurred with that caused the session associated with the gaming application to terminate;
based at least on the event occurring, allocate, during a second session associated with the gaming application, at least one of one or more second processing resources or one or more second memory resources to the client device;
apply, using the first data package and using the at least one of the one or more second processing resources or the one or more second memory resources, one or more first changes to a first portion of files associated with the gaming application; and
apply, using the second data package and using the at least one of the one or more second processing resources or the one or more second memory resources, one or more second changes to a second portion of the files associated with the gaming application.

18. The system of claim 12, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to store one or more data packages during a session associated with a gaming application, the one or more data packages including data representing one or more portions of one or more files that were changed during the session associated with the gaming application.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
